(19) United States
(12) Patent Application Publication
(10) Pub. No.: US 2016/0002097 A1
(43) Pub. Date: Jan. 7, 2016

(54) PANE ARRANGEMENT WITH INFRARED-DAMPING COATING

(71) Applicant: SAINT-GOBAIN GLASS FRANCE, Courbevoie (FR)

(72) Inventors: Sebastian SCHMIDT, Stuttgart (DE); Choung LAI, Acton, MA (US); Aziz MAHFOUD-FAMILIA, Shrewsbury, MA (US); Laetitia MASSAULT, Margny-les-Compiegne (FR)

(73) Assignee: SAINT-GOBAIN GLASS FRANCE, Courbevoie (FR)

(21) Appl. No.: 14/770,158

(22) PCT Filed: Oct. 10, 2013
(86) PCT No.: PCT/EP2013/071137

§ 371 Date: Aug. 25, 2015

Related U.S. Application Data
(60) Provisional application No. 61/768,994, filed on Feb. 25, 2013.

(51) Int. Cl. C03C 17/34; G02B 5/20; G02B 1/14

(52) U.S. Cl. CPC C03C 17/3405; G02B 1/14; G02B 5/208; C03C 2217/47; C03C 2217/48; C03C 2217/74; C03C 2217/78

(57) ABSTRACT

Pane arrangement (I) with coating (2) comprising at least
a transparent substrate (1),
a primer (2.1) on at least one subregion of the substrate (1), said primer containing at least one first UV absorber (4.1) as well as at least two IR absorbers (3.1, 3.2) in the form of dispersed nanoparticles, and
a scratchproof coat (2.2) on the surface of the primer (2.1), said scratchproof coat containing at least one second UV absorber (4.2),
   wherein the first IR absorber (3.1) is a hexaboride of the general formula XB₆ and X=Y, Sr, La, Ce, Pr, Nd, Sm, Eu, Gd, Tb, Dy, Ho, Er, Tm, Yb, or Lu, and the second IR absorber (3.2) is indium tin oxide or antimony tin oxide.

The invention relates to a pane arrangement with infrared-damping coating, a method for its production, and its use.

In the automotive sector, there is a trend toward increasingly larger glass surfaces that give an aesthetically pleasing impression and ensure adequate entry of daylight. However, in particular, motor vehicles with sunroofs are enjoying ever increasing popularity. But, especially in the summer, the infrared portion of sunlight causes strong heating up of the vehicle interior, with panes with large light-entry surfaces proving to be disadvantageous. In this, besides the visible range of the electromagnetic spectrum from 380 nm to 780 nm, especially the near-infrared range (NIR) between 780 nm and 2500 nm plays a large role. In addition to increased energy consumption of the climate control system, warming has a disadvantageous effect both on the physical comfort of the vehicle occupants and the ability of the driver to concentrate. In order to prevent such negative effects, sunroofs have, to date, mostly been manufactured from mineral glass, since this material has only low transmittance in the NIR range of the light spectrum. Due to rising energy prices, the fuel consumption of motor vehicles increasingly attracts the attention of consumers, as a result of which a development toward fuel-conserving models is also to be observed on the part of the automotive industry. The method of choice for this is primarily vehicle weight reduction. With regard to motor vehicle glazings, this weight reduction is realized primarily through the use of plastic materials. However, frequently used thermoplastic plastics such as polycarbonates or polymethyl methacrylates have high transmittance for IR radiation, which results in excessive heating up of the passenger compartment from sunlight. This effect can be moderated by darkening arrangements, as disclosed, for example, in EP 2394832 A1, wherein it proved, however, more effective to prevent the very penetration of the infrared radiation through the pane. To that end, infrared-absorbing substances can be integrated into the pane in quite varied ways.

Infrared-absorbing substances can, for example, be integrated directly into the basic polymeric body of the pane. In combination with the established thermoplastic plastics, primarily indium tin oxide, antimony tin oxide, and tungsten compounds as well as the quite varied metal hexaborides, preferably lanthanum hexaboride, are used as IR radiation-absorbing substances that are already introduced into the polymeric mass during the extrusion process. Such polymeric compositions with IR absorbing additives are described, for example, in EP 1 865 027 A1, DE 100 06 28 A1, and EP 1 559 743 A1.

In addition, methods for applying IR absorbing substances in the form of a coating to the surface of the polymeric workpiece are also known. For example, an infrared radiation-absorbing additive is applied on the surface of the pane together with a polymeric dispersant in a solvent and the solvent is then removed by drying. An indium tin oxide-containing coating is disclosed, for example, in U.S. Pat. No. 5,518,810, whereas U.S. Pat. No. 7,238,418 B2 describes the use of hexaboride nanoparticles in such coatings.

Particularly advantageous is the combination of multiple substances that absorb in different ranges and thus cover the wavelength range of the infrared spectrum from 700 nm to 2500 nm as completely as possible. However, previously known combinations of two IR absorbers such as antimony tin oxide and lanthanum hexaboride in one coating layer result in increased hazing of the pane. For this reason, in US 2009/0291295, the combination of an antimony tin oxide-containing coating with a lanthanum hexaboride-coating is proposed.

However, many established IR absorbers such as indium tin oxide and antimony tin oxide, in particular indium tin oxide, decompose under the influence of UV radiation, as a result of which the infrared-damping properties of the glazing are lost over time.

Coating the pane is also advantageous with regard to the resistance capability of the surface, for example, to mechanical damage. Such protective coatings are, in particular, necessary for motor vehicle glazings since they are exposed to strong demands from environmental influences and, at the same time, must satisfy high quality requirements, for instance, with regard to surface quality and transparency. To ensure optimum adhesion of the coat on the surface of a workpiece to be coated, the application of a permanently adhering coat is preferably done in a two-stage process. In a first step, a primer that produces a chemical or physical bond between the polymeric workpiece and the topcoat is applied. After the application and curing of the primer, the functional layer can be applied. The functional layer and the primer can also contain, in addition to coloring compounds and pigments, components to increase scratch resistance, for example, nanoparticles. A scratchproof coat referred to as hardcoat is usually applied as a functional layer on the primer.

The object of the invention is to provide a pane arrangement with infrared-damping coating improved relative to the prior art, which both satisfies the requirements with regard to scratch resistance of the coating and retains its infrared-damping properties over a long service life, as well as to provide an economical method for its production.

The object of the present invention is accomplished, according to the invention, by a pane arrangement with a scratchproof coating, which absorbs IR radiation, as well as an economical method for its production according to the independent claims 1, 13, and 15. Preferred embodiments emerge from the subclaims.

The pane arrangement according to the invention with coating comprises at least a transparent substrate, a primer on at least one subregion of the substrate, as well as a scratchproof coat on the surface of the primer. The scratchproof coat, also referred to as hardcoat or topcoat, preferably covers the entire surface of the primer. The coating is a multilayer system comprising the primer as a first layer and the scratchproof coat as a second layer. The primer has the task of promoting adequate adhesion between a scratchproof coat and a transparent substrate. The primer includes at least two different IR absorbers, which are introduced therein in the form of dispersed nanoparticles. A first IR absorber is a hexaboride of the general formula XB₆, wherein X comes from the group of yttrium (X=Y), strontium (X=Sr), lanthanum (X=La), cerium (X=Ce), praseodymium (X=Pr), neodymium (X=Nd), samarium (X=Sm), europium (X=Eu), gadolinium (X=Gd), terbium (X=Tb), dysprosium (X=Dy), holmium (X=Ho), erbium (X=Er), thulium (X=Tm), ytterbium (X=Yb), and lutetium (X=Lu). Indium tin oxide or antimony tin oxide is used as the second IR absorber in the primer. The primer further contains at least one first UV absorber, while at least one second UV absorber is contained in the scratchproof coat.

As a first IR absorber, lanthanum hexaboride is preferably used. Lanthanum hexaboride absorbs IR radiation in a wavelength range from ca. 750 nm to 1250 nm, with the remaining fraction of transmitted radiation depending on various factors such as particle size. However, the smaller the particle size of the desired nanoparticles, the more complicated their production. The use of excessively large particle sizes is, however, not recommended since, with size, the light scattering of the particles also increases. The average particle size of the lanthanum hexaboride nanoparticles used in a preferred embodiment is between 5 nm and 200 nm, preferably between 10 nm and 150 nm, particularly preferably between 10 nm and 80 nm. Any size distribution of the nanoparticles can be present; however, the size distribution is preferably present in the form of a Gaussian distribution curve.

In a preferred embodiment, at least one third IR absorber is included in the scratchproof coat. The third IR absorber is particularly preferably antimony tin oxide or lanthanum hexaboride, which have higher UV stability than indium tin oxide. The compositions and particle sizes of the third IR absorber are within the value ranges indicated for the first IR absorber and the second IR absorber, with these not necessarily having to assume the same values.

As a second IR absorber, both indium tin oxide and antimony tin oxide can be used. Indium tin oxide and antimony tin oxide both absorb IR radiation in the range from 1700 nm to 2500 nm. The second and the third IR absorbers can, but need not, be made of the same substance. Primarily, mixed oxides with a content of 85% to 95% indium(III) oxide and 5% to 15% tin(IV) oxide, or a content of 5% to 15% antimony(V) oxide and 85% to 95% tin(IV) oxide are suitable for use in the coating according to the invention. Particularly preferred are the mixed oxides (In₂O₃)_{0.9} (SnO₂)_{0.1}, (In₂O₃)_{0.95} (SnO₂)_{0.05}, (Sb₂O₅)_{0.1} (SnO₂)_{0.9}. The average particle sizes of the indium tin oxide and of the antimony tin oxide are between 5 nm and 200 nm, preferably between 10 nm and 150 nm, particularly preferably between 10 nm and 80 nm. Most particularly preferably, the size distribution of the nanoparticles has the form of a Gaussian distribution curve; however, mixtures with any particle distribution can also be used. For reasons of cost, antimony tin oxide is preferably used.

In another embodiment of the invention, multiple different IR absorbers, but preferably not more than five IR absorbers, may be included in the coating made of the primer and scratchproof coat. The selection and combination of the IR absorbers is done such that the absorption spectra of the substances advantageously complement each other and yield, altogether, the most extensive absorption possible in the entire wavelength range between 750 nm and 2500 nm. At the same time, the IR absorbers used should have the least absorption possible in the range of visible light from 380 nm to 780 nm.

Hazing of the pane arrangement as a result of mixing different IR absorbers in the primer is prevented in that the IR absorbers are dispersed into the coating material by means of ultrasonic dispersion. The pane arrangement with infrared-damping coating according to the invention has hazing of less than 5%, preferably less than 4%, based on a substrate coated on both sides. The hazing of the pane was determined using a HunterLab UltraScan Pro from the company HunterAssociates Laboratory Inc. in accordance with ASTM D1003. As a result of the introduction of the IR absorbers into the primer, any substrates can be used, even those whose material composition is not compatible with the usual IR absorbers. This enables a substantially greater range of materials. The use of organic absorbers in the polymeric mass also has a negative effect on the strength of the material. This problem is completely avoided through the use according to the invention of inorganic IR absorbers in the primer.

The primer contains 0.5 wt.-% to 20 wt.-%, preferably 1 wt.-% to 10 wt.-%, particularly preferably 3 wt.-% to 7 wt.-% of the first IR absorber and 1 wt.-% to 30 wt.-%, preferably 5 wt.-% to 20 wt.-%, particularly preferably 10 wt.-% to 15 wt.-% of the second IR absorber, based in each case on the total solids content of the primer in the solvent-free state after drying.

Other absorbers possibly added have a content of a maximum of 30 wt.-%, with the total amount of the IR absorbers in the primer not exceeding a value of 70 wt.-% based on the solvent-free prime.

The primer further includes at least one first UV absorber, preferably from the group of triazine derivatives, phenyltriazine derivatives, triazole derivatives, benzotriazole derivatives, malonates, oxamides, silylated benzophenone derivatives, dibenzoyl resorcinol derivatives, diaryl cyanoacrylates, oxalanilides, aluminum oxide, cerium oxide, zirconium oxide, zinc oxide, titanium oxide, and iron oxides. Suitable UV absorbers are sufficiently known to the person skilled in the art and can be looked up, for example, in chapter 2.3 of the “Plastics Additives Handbook 6th Edition” (Hans Zweifel, Ralph D. Maier, Michael Schiller, published by Hanser-Verlag). Particularly preferably used are organic UV absorbers, in particular 4-(3-triethoxysilylpropoxy)-2-hydroxy benzophenone and/or dibenzoyl resorcinol derivatives. The first UV absorber used in the primer complements the second UV absorber of the scratchproof coat in its function. Only a portion of the UV radiation strikes the first UV absorber, since a portion was already absorbed by the second UV absorber of the overlying scratchproof coat. Organic UV absorbers additionally added in the primer are only limitedly suitable for use in the scratchproof coat, as they soften the polymeric network of the coat and thus negatively affect the strength of the surface of the coat.

The scratchproof coat includes a content of 0.1 wt.-% to 5 wt.-%, preferably 0.5 wt.-% to 2.5 wt.-%, of UV absorbers based on the total solids content of the scratchproof coat. At least one second UV absorber is included in the scratchproof coat, as well as, optionally, additional different UV absorbers. The use according to the invention of the second UV absorber in the scratchproof coat enables filtering out a portion of the UV radiation already before it strikes the primer. The IR absorbers contained in the primer are thus partially protected against decomposition initiated by UV radiation. The synergistic combination according to the invention of a UV absorbing scratchproof coat with an IR absorber-containing primer results in a substantially higher aging resistance of the pane.

The second UV absorber preferably comes from the group including triazine derivatives, phenyltriazine derivatives, triazole derivatives, benzotriazole derivatives, malonates, oxamides, silylated benzophenone derivatives, dibenzoyl resorcinol derivatives, diaryl cyanoacrylates, oxalanilides, aluminum oxide, cerium oxide, zirconium oxide, zinc oxide, titanium oxide, and iron oxides. Particularly preferably, an inorganic UV absorber or an inorganically modified UV absorber with an organic skeleton is used as a second UV absorber, since purely organic UV absorbers damage the polymeric network of the scratchproof coat. In addition to the inorganic compounds mentioned, other inorganic UV absorbers as well as inorganically modified UV absorbers with an organic skeleton are familiar to the person skilled in the art and can be looked up, for example, in “Plastics Additives Handbook 6th Edition” (Hans Zweifel, Ralph D. Maier, Michael Schiller, published by Hanser-Verlag). Other UV absorbers added to the scratch proof coat beyond the second UV absorber can be of a purely organic nature, with the concentration selected such that no or only an insignificant negative impact on the polymeric network of the scratchproof coat occurs. In a particularly preferred embodiment, a third UV absorber with a purely organic structure is included in addition to the second UV absorber.

In addition, the scratchproof coat can, optionally, include a third IR absorber, which is present in a weight fraction from 0 wt.-% to 20 wt.-%, preferably 0 wt.-% to 10 wt.-% and particularly preferably 1 wt.-% to 5 wt.-%, based on the total solids content of the scratchproof coat. Other IR absorbers possibly present and the third IR absorber do not exceed in all a total weight fraction of 30 wt.-%.

The primer is applied with a thickness from 1 μm to 10 μm, preferably 2 μm to 4 μm, on the transparent substrate. The scratchproof coat is applied with a thickness from 3 μm to 15 μm, preferably 4 μm to 10 μm, on the primer. The thicknesses of the individual layers are measured in the dry state after the fixing of the coat. The total thickness of all layers is a maximum of 20 μm to prevent irregularities and cracks in the coating.

The transparent substrate preferably includes at least one transparent thermoplastic plastic, preferably polycarbonates, polymethyl methacrylate, polyurethanes, polyesters, polyethylene terephthalate, polybutylene terephthalate, polyethylene naphthalate, polyethylene, polypropylene, polystyrene, polyether ether ketone, polyvinyl chloride, acrylonitrile butadiene styrene, polyamides, and/or polylactate, and/or mixtures or copolymers thereof, particularly preferably polycarbonates or polymethyl methacrylate, insbesondere polycarbonate.

The transparent substrate can assume quite varied geometric shapes and can, depending on the area of use, be flat or curved. Particularly for use in the automotive sector, more or less strongly curved panes are necessary, with the bending not having to be uniform, but rather, relatively strong bending can be present, particularly in the edge region of the pane.

Optionally, the transparent substrate can be surrounded by an opaque frame in the outer edge region of the pane, which frame can even be formed in one piece with the substrate. This opaque edge region of the pane advantageously conceals the adhesive strand applied in this region during the installation of the pane. The opaque frame can be made of, for example, a polymeric mass opaquely tinted by pigments, which mass is formed directly on the transparent substrate in a multicomponent injection molding process.

Depending on the field of application, tinting of the glazing may also be desirable. For this purpose, pigments can be incorporated into the still moldable polymeric mass of the transparent substrate already during the extrusion procedure. Alternatively, the use of tinted paints is also possible, wherein the pigments are introduced into the primer and/or into the scratchproof coat. Suitable pigments are familiar to the person skilled in the art.

The transparent substrate optionally includes an IR absorber, preferably lanthanum hexaboride, indium tin oxide and/or antimony tin oxide, and/or mixtures thereof, particularly preferably lanthanum hexaboride.

The primer further includes at least one solvent, preferably 1-methoxy-2-propanol, methyl isobutyl ketone, 4-hydroxy-4-methyl-2-pentanone, and/or mixtures or derivatives thereof. The primer further contains polyacrylates, polyurethanes, epoxy resins, melamine resins, alkyd resins, and/or mixtures thereof, preferably polyacrylates. In addition, adhesion promoters, stabilizers, UV absorbers, and/or flow agents can be added to the primer. Phosphines, preferably triphenylphosphine, are used, for example, as thermal stabilizers.

A polysiloxane-based coat is preferably used as the scratchproof coat; this particularly preferably involves organically modified silicon resins. Alternatively, the use of epoxy- or acrylic-based paint systems would also be conceivable. The scratchproof coat further includes solvents, preferably water, alcohols, particularly preferably methanol, 2-propanol, n-butanol, 1-methoxy-2-propanol, and/or mixtures or derivatives thereof. To increase the scratch resistance of the topcoat, colloidal nanoparticles, for example, SiO₂, ZrO₂, and/or TiO₂, preferably SiO₂, are introduced into the coating, by which means the mechanical stability and the abrasion resistance of the coating are advantageously improved. Such nanoparticles can, with the use of suitable particle sizes, also function as UV absorbers. Furthermore, in a preferred embodiment, at least one third IR absorber, preferably antimony tin oxide or lanthanum hexaboride, is included. The scratchproof coat is further provided with UV absorbers. Such combinations have strong absorption bands in the wavelength range from 1 nm to 380 nm of the electromagnetic spectrum. As a result, UV-radiation-initiated chain degradation of the polymeric structure as well as decomposition of other material components, for example, the IR absorbers, are avoided. Especially indium tin oxide presents strong decomposition under the action of UV radiation. When a scratchproof coat that successfully shields UV radiation is applied on an indium tin oxide-containing primer, the decomposition reaction of the indium tin oxide can be slowed and thus the service life of the pane arrangement according to the invention can be significantly prolonged.

The additives used in the primer and in the scratchproof coat, such as IR absorbers, UV absorbers, and the great variety of auxiliary materials are preferably introduced into the paint formulation by dispersion in a solvent. Preferably used as solvents are alcohols, ethers, or ketones, particularly preferably methanol, 2-propanol, n-butanol, 4-hydroxy-4-methyl-2-pentanone, methyl isobutyl ketone, 1-methoxy-2-propanol, and/or mixtures or derivatives thereof, in particular 1-methoxy-2-propanol. 1-methoxy-2-propanol need not be used in isomerically pure form; a technical mixture of ca. 95% to 99% 1-methoxy-2-propanol and 1% to 5% 2-methoxy-1 -propanol suffices.

For better dispersion of the individual components among each other, dispersants familiar to the person skilled in the art, for example, commercially available polyacrylate-based dispersants, can be used. Sufficiently good dispersion can, however, also be obtained with purely mechanical methods.

In a particularly preferred embodiment of the pane arrangement according to the invention, the primer contains a combination of the IR absorbers lanthanum hexaboride and indium tin oxide as well as dibenzoyl resorcinol derivatives as first UV absorbers and the scratchproof coat contains antimony tin oxide as additional IR absorbers as well as titanium dioxide as second UV absorbers. Due to the decomposition sensitivity of the IR absorbers, they must be protected as well as possible against UV radiation. For this purpose, the pane arrangement according to the invention includes a UV-absorbing scratchproof coat directly above the primer, such that UV radiation is damped already before striking the IR absorbers of the primer and the decomposition of these IR absorbers is thus inhibited. By this means, the aging resistance of the pane according to the invention can be significantly increased. To further improve the infrared-damping properties of the pane, an IR absorber is also introduced into the scratchproof coat to already filter out a portion of the radiation. The combination of the infrared-damping coating with a multilayer system consisting of a primer and a scratchproof layer known per se further enables eliminating another production step for application of an IR-damping coating. Moreover, the use of the coating according to the invention on an unmodified polycarbonate is significantly more economical than the use of IR-absorbing polycarbonate substrates.

Commercially available coating systems which can constitute the basis for the production of the pane arrangement according to the invention are, for example, the scratchproof coats AS4700 and AS4000 from Momentive Performance Materials in combination with the primers SHP470, SHP470FT-2050, and SHP401 from the same company, with the use of the primers SHP470 and SHP470FT-2050 in combination with the scratchproof coat AS4700 having proved to be particularly suitable. A suitable dispersion containing 21.5 wt.-% lanthanum hexaboride can be obtained under the trade name KHSD-06 from Sumitomo Metal & Mining. Indium tin oxide is available as a dispersion containing 42 wt.-% (In₂O₃)_{0.9} (SnO₂)_{0.1} with a particle size of 45 nm under the trade name TRB SH7080 from Advanced Nano Products (ANP). Antimony tin oxide can be obtained as a dispersion with 42 wt.-% (Sb₂O₅)_{0.1} (SnO₂)_{0.9} containing nanoparticles with an average size of 45 nm under the trade name TRB SR6070 from Advanced Nano Products (ANP).

The pane arrangement according to the invention with infrared-damping coating is preferably coated on both sides, with the layer structure consisting of primer and scratchproof coat particularly preferably identical on both sides.

The invention further comprises a method for producing a pane arrangement with infrared-damping coating. A transparent substrate is prepared by injection molding or thermal forming and subsequently provided with a coating in multiple layers. Optionally, the transparent substrate can have an opaque edge region, which can be applied either in the injection molding process in the form of an opaque polymeric component or is applied before the forming of a polymeric blank as a black imprint thereon. In a first process step, the transparent substrate is provided with a primer that includes at least one first IR absorber and one second IR absorber. The primer is applied to the surface of the transparent substrate by flow coating, spray coating, or dip coating or using applicator rolls. Preferably, the flow coating method is used. The primer can then be fixed, preferably by temperature treatment, particularly preferably by heating to 100° C. to 150° C. for 40 minutes to 60 minutes, in particular to 125° C. for 50 minutes. Whether fixing is required, depends in particular on the coating system used. In the next process step, the scratchproof coat containing at least one UV absorber is applied on the surface of the primer. The primer acts to promote adhesion. The scratchproof coat is also applied by flow coating, spray coating, or dip coating or using applicator rolls, with the flow coating method preferably being used. The scratchproof coat is finally fixed, preferably by a temperature treatment, particularly preferably by heating to 100° C. to 150° C. for 60 minutes to 100 minutes, in particular at 130° C. for 80 minutes.

The IR absorbers and UV absorbers, as well as possible additives, such as zirconium dioxide, stabilizers, dispersants, pigments, and/or other auxiliary materials are, in a possible embodiment of the method according to the invention, first dispersed with a solvent and only introduced into the coating formulation thereafter. This ensures optimum distribution of the additives in the coating or polymeric composition and prevents agglomeration of the additives. Then, a defined amount of the solvent containing these additives is introduced and dispersed in the paint formulation of the primer and of the scratchproof coat as well as, optionally, in the polymeric mass of the transparent substrate.

The invention further comprises the use of a pane arrangement with infrared-damping coating in motor vehicles, marine vessels, aircraft, as building glazing or architectural glazing. Preferably, the pane arrangement is used in motor vehicles, particularly preferably as a roof glazing in motor vehicles, for example, as a sunroof.

In the following, the invention is explained in detail with reference to drawings. The drawings in no way restrict the invention.

They depict:

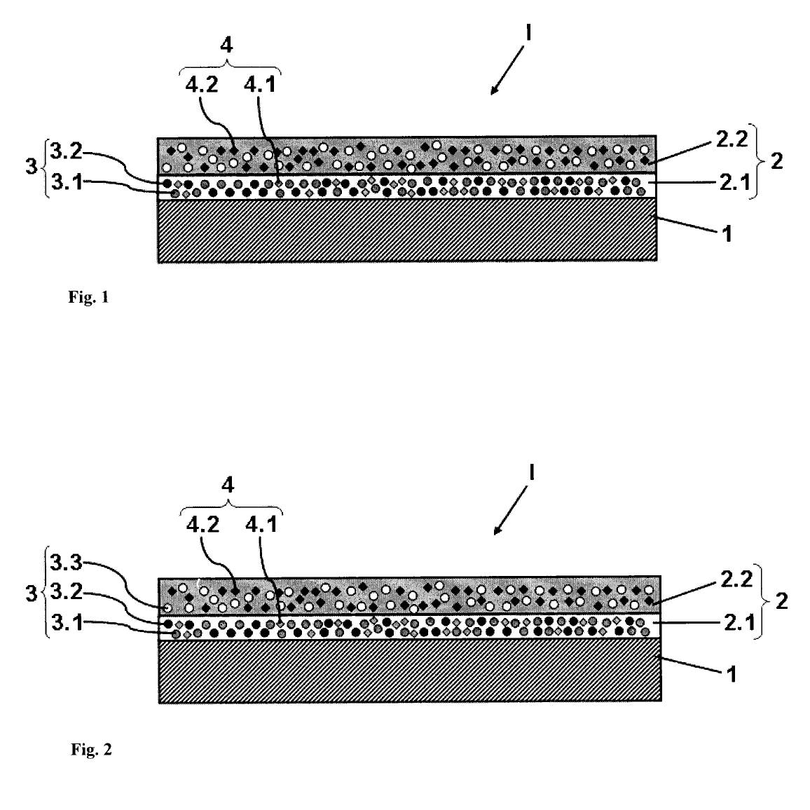

FIG. 1 a first embodiment of a pane arrangement with infrared-damping coating according to the invention.

FIG. 2 another embodiment of a pane arrangement with infrared-damping coating according to the invention.

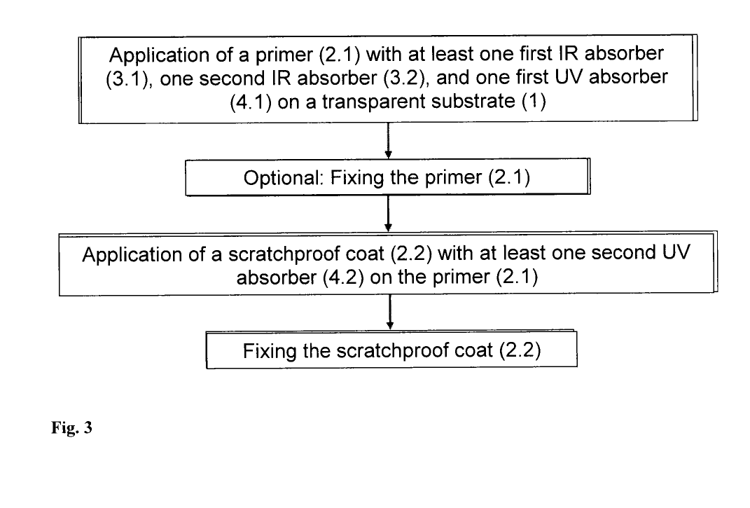

FIG. 3 a flowchart of the method for producing a pane arrangement with infrared-damping coating.

FIG. 1 depicts a pane arrangement (I) with infrared-damping coating (2), wherein a primer (2.1) is applied on a transparent substrate (1) and a scratchproof coat (2.2) is applied on the primer (2.1). The coating (2) is thus composed of a multilayer system in which the primer (2.1) acts as an adhesion promoter for the scratchproof coat (2.2). The primer (2.1) contains two IR absorbers (3) in the form of dispersed nanoparticles, wherein lanthanum hexaboride is used as a first IR absorber (3.1) and indium tin oxide is used as a second IR absorber (3.2). The primer (2.1) is based on the coating formulation available under the trade name SHP-470 (Momentive Performance Materials), wherein, per gram of this coating formulation, 0.034 g KHDS-06 (Sumitomo Metal & Mining) containing 21.5 wt.-% LaB₆, as well as 0.024 g indium tin oxide particles with a size of 45 nm are added. Indium tin oxide is used here in the form of the dispersion TRB SH7080 available from Advanced Nano Products (ANP). A first UV absorber (4.1) is already contained in the coating formulation SHP-470 and need not be added separately. The scratchproof coat (2.2) contains a second UV absorber (4.2). The scratchproof coat available under the trade name AS4700 (Momentive Performance Materials) already contains a second UV absorber (4.2). As the term “scratchproof coat” already implies, additives such as SiO₂ nanoparticles that increase mechanical stability and scratch resistance of the coating are present in such coats and also in the hardcoat formulation AS4700. The pane arrangement (I) according to the invention enables, particularly advantageously, eliminating a process step during coating, as the infrared-damping coating and the scratchproof coat (2.2) can be combined. Furthermore, the first IR absorber (3.1) introduced in the primer (2.1) and the second IR absorber (3.2) are protected against UV radiation by the second UV absorber (4.2) of the scratchproof coat (2.2) such that the aging resistance of the pane arrangement (I) can be significantly improved.

FIG. 2 depicts a pane arrangement (I) in accordance with FIG. 1, wherein, in addition, to the components described there, a third IR absorber (3.3) is contained in the scratchproof coat (2.2). The scratchproof coat available under the trade name AS4700 (Momentive Performance Materials) already contains a second UV absorber (4.2) such that only antimony tin oxide has to be added as a third IR absorber (3.3). In this case, 0.024 g antimony tin oxide with a particle size of 45 nm is added per gram of the hardcoat formulation AS4700. Antimony tin oxide is used in the form of the dispersion TRB SR6070 available from Advanced Nano Products (ANP).

FIG. 3 depicts a flowchart of the method according to the invention for producing a pane arrangement (I) with infrared-damping coating. In a first step, a primer (2.1) with at least one first IR absorber (3.1), one second IR absorber (3.2), and one first UV absorber (4.1) are applied on the surface of a transparent substrate (1). Optionally, the primer (2.1) can be fixed in a subsequent step, preferably by a temperature treatment. Solvents contained in the primer (2.1) are removed. After that, a scratchproof coat (2.2) with at least a second UV absorber (4.2) is applied on the fixed primer (2.1). Finally, the scratchproof coat (2.2) is fixed, preferably using a temperature treatment. As a result of the introduction of the IR absorbers (3) directly into the primer (2.1) of the coating system, the application of an infrared-damping coating as an additional layer is eliminated.

### LIST OF REFERENCE CHARACTERS

I pane arrangement
1 transparent substrate
2 coating
2.1 primer
2.2 scratchproof coat
3 IR absorber
3.1 first IR absorber
3.2 second IR absorber
3.3 third IR absorber
4 UV absorber
4.1 first UV absorber
4.2 second UV absorber

1. A pane arrangement, comprising a coating comprising:
a transparent substrate;
a primer on at least one subregion of the substrate, said primer comprising at least one first UV absorber as well as at least two IR absorbers in the form of dispersed nanoparticles; and
a scratchproof coat on a surface of the primer, said scratchproof coat comprising at least one second UV absorber;
wherein:
the first IR absorber is a hexaboride of the general formula XB₆, in which X=Y, Sr, La, Ce, Pr, Nd, Sm, Eu, Gd, Tb, Dy, Ho, Er, Tm, Yb, or Lu; and
the second IR absorber is indium tin oxide or antimony tin oxide.

2. The pane arrangement of claim 1, wherein two or more IR absorbers are contained in the coating.

3. The pane arrangement of claim 1, wherein the first IR absorber is lanthanum hexaboride.

4. The pane arrangement of claim 3, wherein the first IR absorber is lanthanum hexaboride with an average particle size from 5 nm to 200 nm.

5. The pane arrangement of claim 1, wherein the second IR absorber is antimony tin oxide.

6. The pane arrangement of claim 1, wherein the second IR absorber is indium tin oxide.

7. The pane arrangement of claim 5, wherein the second IR absorber has an average particle size from 5 nm to 200 nm.

8. The pane arrangement of claim 1, wherein the first UV absorber is an organic UV absorber.

9. The pane arrangement of claim 1, wherein the second UV absorber is an inorganic UV absorber or an inorganically modified UV absorber with an organic skeleton.

10. The pane arrangement of claim 1, wherein the scratchproof coat comprises a third IR absorber.

11. The pane arrangement of claim 1, wherein the scratchproof coat comprises at least one siloxane nanoparticle, silicon dioxide nanoparticle, or a mixture thereof.

12. The pane arrangement of claim 1, wherein the primer comprises at least one polyacrylate, polyurethane, epoxy resin, melamine resin, alkyd resin, or a mixture thereof.

13. A method for producing the pane arrangement of claim 1, the method comprising:
a) applying the primer comprising at least one first IR absorber, one second IR absorber, and one first UV absorber on the transparent substrate;
b) applying the scratchproof coat on the primer; and
c) fixing the scratchproof coat.

14. The method of claim 13, wherein the fixing of the scratchproof coat occurs performing by temperature treatment.

15. An article comprising the pane arrangement of claim 1, the article being selected from the group consisting of a motor vehicle, a marine vessel, an aircraft, a building glazing, and an architectural glazing.
